(19) United States
(12) Patent Application Publication
(10) Pub. No.: US 2005/0108086 A1
(43) Pub. Date: May 19, 2005

(54) System that provides service to monitor, evaluate, train and support human resources

(76) Inventor: Gary Lee Kosman, Granada Hills, CA (US)

Correspondence Address: Gary Kosman, 12932 Jolette Ave, Granada Hills, CA, 91344, US

(21) Appl. No.: 10/986,608

(22) Filed: Nov. 13, 2004

Related U.S. Application Data
(60) Provisional application No. 60/520,186, filed on Nov. 14, 2003.

(51) Int. Cl. G06F 17/60

(52) U.S. Cl. 705/10

(57) ABSTRACT

A system that compiles and evaluates survey data, uses a two-tiered permissions and workflow system to turn some survey data into support resources for human resources using the system, delivers support resources to survey takers that are targeted to survey takers' survey data, and compiles and displays the survey data.

### CROSS REFERENCE TO RELATED APPLICATION

The present application claims priority from U.S. provisional application No. 60/520,186 entitled “Service to Monitor, Evaluate, Train and Support Human Resources,” filed Nov. 14, 2003, said application incorporated herein by reference.

### BACKGROUND OF THE INVENTION

The present invention relates to methods and systems for monitoring, evaluating, training, and supporting human resources.

Organizations dependent on monitoring, evaluating, training, and supporting their human resources have common needs. These organizations: need to ensure that their human resources have the necessary training to work towards a common mission; need to support their human resources when the resources encounter challenges they find themselves unable to hurdle; need to build and maintain “institutional memory,” a record of what processes, actions and strategies work and do not work under certain circumstances; and need to be able to take and respond to the pulse of their human resources at any time to ensure that they are being properly trained and supported.

The main circumstances hindering many organizations from meeting these needs are that: many organizations lack financial and human resources to adequately monitor, evaluate and support their employees, contractors, volunteers and interns; too often, human resources managers spend exorbitant amounts of time compiling, analyzing and writing up data to evaluate their human resources' progress, limiting or eliminating time to use that data to strengthen their organizations and support their human resources; and, many human resources and human resources managers have not been well served by existing services that attempt to create, manage and/or facilitate networks for human resources to share and build on each other's experiences, hindering organizational performance and personnel development and growth.

No single existing service (aside from the present invention) meets organizations' human resources monitoring, evaluating, training and support needs. Rather, existing services only address one or two of the needs at a time. For example, some existing services provide solutions to support human resources or to build and maintain institutional memory or to monitor and evaluate human resources. Many stand-alone human resources support systems are also insufficient because they require human resources or human resources managers to browse or search a database, or “attend” online courses to find helpful supports, rather than instantly delivering targeted supports to human resources as soon as the system becomes aware of a human resource's goals and challenges.

The present invention turns the heretofore disparate processes of monitoring, evaluating and supporting human resources while building and maintaining institutional memory into a one-step, seamless process. The invention disclosed in this application could be effectively used to monitor, evaluate, train, and support: volunteers in a variety of nonprofit organizations (including but not limited to academic tutoring, coaching and mentoring of various subjects and topics; maternity and motherhood mentoring; and sports coaching); academic tutors, coaches and mentors and other employees working for for-profit companies; employees, interns or volunteers for a variety of organizations working in an area in which those human resources run into identical or similar challenges time and again over short or long time periods; doctors wanting their patients to record their wellness on a regular or irregular basis while providing those patients with helpful information based on their recorded wellness information; field researchers; fellows of foundations or other institutions seeking support and working to build a library of best practices in various fields; teachers in a specific school or school district; teachers of a specific grade level within or across school or school district boundaries; teachers of a specific subject area within or across school or school district boundaries; teachers using a specific text book or curriculum within or across school or school district boundaries; and students participating in a course (academic or otherwise). The invention may also be used to monitor, evaluate and support human resources in organizations, positions and circumstances not mentioned herein.

### SUMMARY OF THE INVENTION

The invention compiles and evaluates survey data, uses a two-tiered permissions and workflow system to turn some survey data into support resources for human resources using the invention, delivers support resources to survey takers that are targeted to survey takers' survey data, and compiles and displays the survey data.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 presents a conceptual overview of one instance of the invention, and is intended to ground readers of this application in the logic guiding the invention's structure and function.

FIG. 2 is a flow diagram illustrating how a customer registers to use the invention.

FIG. 3 is a diagram illustrating the components of the organization home page, the way an HRM enters the Mission Control, and the Mission Control's components.

FIG. 4 illustrates a flow diagram for creating surveys.

FIG. 5 illustrates the “Human Resources Space”—the portion of the system where HRs access surveys and receive support to help them carry out their job functions.

FIG. 6 illustrates how HRs access and complete surveys.

FIG. 7 provides an overview of what actions the system takes as soon as HRs submit surveys to the system.

FIG. 8 is a flow diagram detailing Tier 1 of the Two-Tiered Success Story Permissions/Workflow System.

FIG. 9 is a flow diagram detailing Tier 2 of the Two-Tiered Success Story Permissions/Workflow System.

FIG. 10 illustrates how HRMs gain access to and use the challenge stories HRs contribute via their surveys.

FIG. 11 illustrates how HRs gain access to and use the challenge stories HRs contribute via their surveys.

FIG. 12 is a flow diagram illustrating how the system attempts to use the Immediate Human Resources Support System to provide an HR identifying challenges in a survey.

FIG. 13 illustrates how the system updates an HR's Human Resources Space after an HR completes a survey.

FIG. 14 is a flow diagram illustrating how a human resources manager uses the invention to view survey data for individual human resources.

FIG. 15 shows that users may view survey data by groups of individual users with shared personal or professional characteristics.

FIG. 16 shows that users may instruct the system to compile and display survey data by all of the HRs in the entire organization over any time period.

FIG. 17 illustrates how populations other than HRMs compile and view HRs' survey data.

FIG. 18 presents the basic structural overview of the system.

### DETAILED DESCRIPTION OF THE INVENTION

Reference will now be made in detail to the preferred embodiments of the invention, examples of which are illustrated in the accompanying figures. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components and circuits have not been described in detail as not to unnecessarily obscure aspects of the present invention.

The present invention relates to a service that automates the processes of monitoring, evaluating, training, and supporting organizations' human resources, and turns those disparate processes into a seamless process. “Human resources” is defined in this disclosure as anyone working, contracting or volunteering for an organization with or without salary or stipend, or anyone who is a student, tutee, mentee, fellow or medical patient. The following pages detail the system's interfaces and components that human resources (HRs), human resources managers (HRMs), and other involved parties use, assuming they choose to use all of the invention's features.

Conceptual Overview

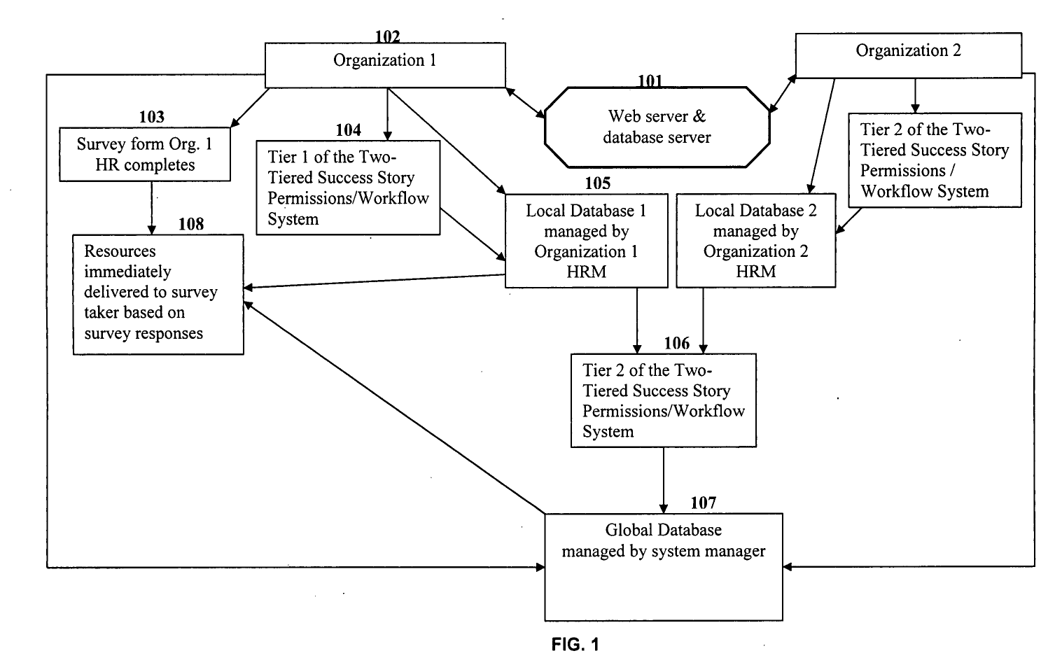

FIG. 1 presents a conceptual overview of one instance of the invention, and is intended to ground readers of this application in the logic guiding the invention's structure and function. Each instance of the invention is accessed via a Web and database server 101, and is used by one or more organizations working in the same content area. “Organizations,” as defined in this application, may vary from the satellite offices or divisions within a larger organization, to separate and independent companies, government organizations or nonprofit organizations operating in the same field. Each organization 102 uses the invention to create a survey for its HRs to complete periodically 103. When completing the surveys, the HRs record successful strategies they've developed as well as challenges they haven't yet overcome. When HRs record strategies, HRMs screen and edit the strategies via Tier 1 of the Two-Tiered Success Story Permissions/Workflow System 104, and use their judgment to determine whether to post those strategies to their organization's own database of strategies (referred to throughout this document as the Local Database) 105. The Local Database can only be accessed by HRs, HRMs and other credentialed users from the organization managing its Local Database. Individuals managing the entire instance of the invention (“system managers”) use Tier 2 of the Two-Tiered Success Story Permissions/Workflow System 106 to promote the strategies in the Local Database to the Global Database 107, which all organizations using an instance of the invention may access. HRs and HRMs from one organization may access all of the strategies promoted to the Global Database from other organizations using the same instance of the invention. HRs and HRMs may also contribute strategies to be screened for Local and Global Database posting outside of the survey forms.

As soon as an HR submits a survey, so long as she recorded a challenge she has been unable to overcome, the invention instantly searches the Local Database of that HR's organization as well as the Global Database to see whether other HRs and HRMs using the invention have recorded any resources relevant to the survey taker's challenge. If relevant resources exist, the system immediately presents the survey taker with hyperlinks to those resources 108. In this way, HRs learn from other HRs both within and beyond their own organization without using e-mail listservs, online bulletin boards, guidebooks, or conference calls. The survey taker may also instruct the invention to search the public Internet for relevant resources.

HRMs and other credentialed individuals are able to instruct the system to compile HRs' survey data at any time over any time period by a number of variables into statistics, graphs and charts. Those managing the invention and other credentialed individuals are able to compile survey data for any number of organizations using an instance of the invention.

Registration

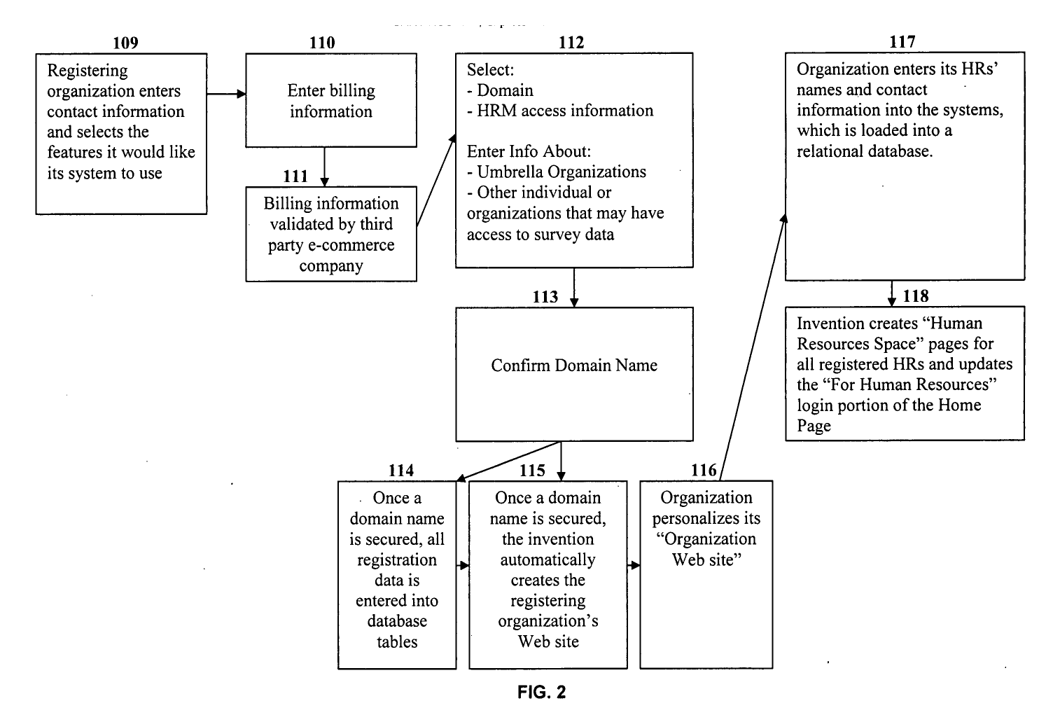

FIG. 2 blocks 109 through 118 represent the process a customer takes to register to use the invention. Registering organizations first pay and sign any contracts offline or via registration forms hosted on a Web site. The registration form on the Web site is completed by filling in text boxes, selecting responses from drop-down menus, and clicking on relevant check boxes and radio buttons. When registering via the Web, the organization goes through the following process: First, as shown in block 109, the organization enters its contact information, whether the organization is involved in an industry or sector for which the system is already managing a Global Database, and which features of the system it would like to use. Then, the organization enters its billing information 110, which is confirmed by an entity such as a third party e-commerce provider 111.

Once the organization's billing information is validated, the organization enters additional data about itself 112 (including whether it's a branch or an affiliate of an “umbrella organization,” defined as an organization that may manage, invest in or oversee one or more organizations using an instance of the invention), selecting whether any umbrella organizations or other individuals or organizations will have access to HRs' survey data, and selecting a domain name and access information (usernames and passwords) to use for its Web site on the system's Web server (hereinafter referred to as “the organization's Web site”). Once the domain name is confirmed 113, the system stores all of the organization's registration data in tables of the system's relational database 114 and creates the organization's Web site 115. If the organization registered using paper forms, the system manager will create the registering organization's Web site by way of entering the data from the paper forms into the system as just described.

Block 116 notes that the organization then personalizes the text on its organization Web site by determining: whether the system should refer to HRs as “human resources” or something else on the system Web pages; whether the system should refer to HRMs as “human resources managers” or something else on the system Web pages; and whether the system should refer to umbrella organizations as “umbrella organizations” or something else on the system Web pages.

Block 117 shows that the registering organization representative then uses one of the following two methods to enter the organization's HRs' names and contact information into the relational database. Option 1 involves the HRM entering each HR's name, e-mail address, access information (i.e., the HRM assigns a username and password for each HR), and if desired, the HR's work location, work site, organization division, sex, age and other variables the organization uses to classify HRs. HRMs can always edit this information later via their Mission Controls (described below). Option 2 involves the HRM providing the system manager with the names, e-mail addresses and preferred access information (usernames and passwords), and any other requested information of the HRs who will use the system. The system manager then enters the HRs' contact information into the system.

Block 118 shows that once HRs' names are entered and confirmed, the system creates a “Human Resources Space” (described below) for each HR, and updates the home page of the organization's Web site by creating at least two main links: “For Human Resources” (from where HRs log in to their Human Resources Space pages) and “For Human Resource Managers” (from where HRMs log in to their private “Mission Control” pages, described below). If the organization registered for umbrella organizations to access its survey data, the system will also create a link on the home page from where umbrella organizations may access HRs' survey data. The home page is described in detail below.

Organization's Home Page and HRM's Mission Control

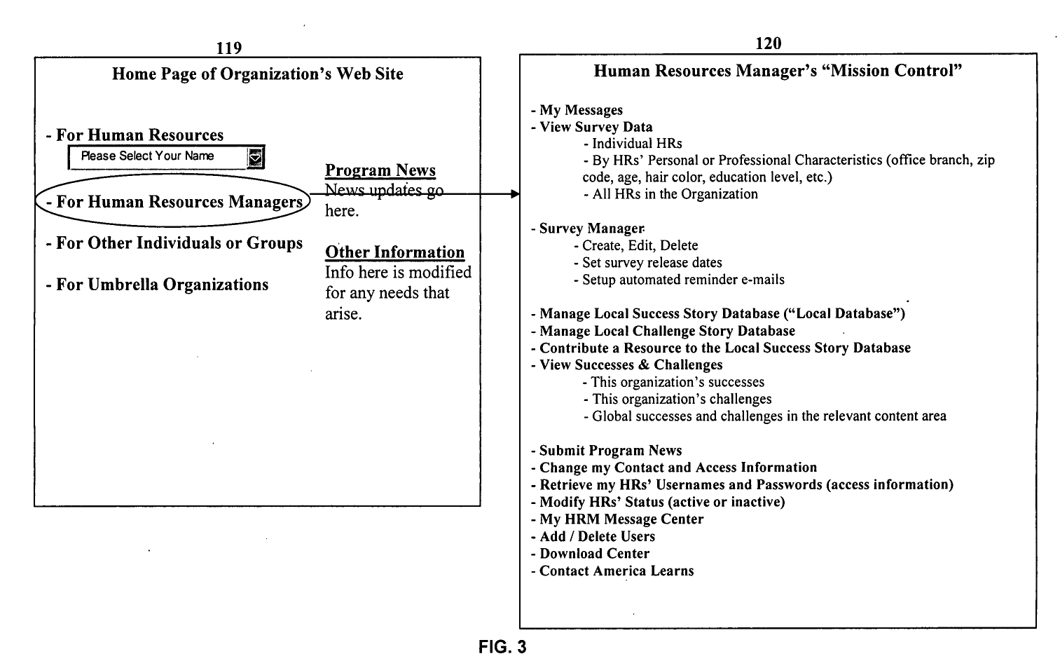

FIG. 3 is a diagram illustrating the components of the organization home page, the way an HRM enters the Mission Control, and the Mission Control's components.

Every organization has a home page 119 that contains a “For Human Resources” link that provides access to HRs' private Human Resources Space pages. HRs enter a pre-assigned username and password to enter their Human Resources pages (described in detail below) as designated during the registration process. Each organization home page also has a “For Human Resources Managers” component that provides access to the HRM's private Mission Control page 120 via a username and password created during the registration process.

The “Program News” component of the organization home page displays any announcements the HRM or service provider enters via a setting within the Mission Control. An “Other Information” component on the page can be modified by the system manager for any needs that arise. For example, through this service component, the system manager could post a notice to some or all system users on all of their organization home pages.

Some organizations may choose to have the “For Other Individuals or Groups in the Organization” component added to their organization home pages. Organizations use this component when they would like individuals in other positions than the HRM to access HR survey data (such as but not limited to the organization's top executives or principal investors). If organizations choose to have data compilation pages for other individuals or groups, the system creates survey data compilation pages for those populations during the registration process and the system adds links to those pages on the organization's home page.

Some organizations may choose to have the “For Umbrella Organizations” component on their organization home pages. The link gives umbrella organizations access to the part of the system that compiles and displays survey data for HRs of any number of organizations they oversee that are currently using the same instance of the system.

An HRM accesses her private “Mission Control” page by clicking on a hyperlink reading “For Human Resources Managers” on her organization's home page. Block 120 shows that the Mission Control page allows HRMs to select options to: Manage their surveys (create, edit, delete, set release dates); Schedule automated survey completion reminders to be send to those HRs who have not completed a survey by a designated point in time (described below); View their survey data by individual HRs, by professional or personal characteristics of HRs (e.g., office branch, department, zip code, age, education level), and by all HRs in the entire organization (described below); Manage their local success story database (described below); Manage their local challenge story database (described below); Change their access information (e.g., usernames and passwords); Change their contact information (including contact name, position title, mailing address, phone number, FAX number, email address, web address); Add or delete HRs from the system (with or without deleting their survey data records as well); Set HRs as “active” or “inactive” (inactive HRs will not receive e-mail reminders to complete surveys and will not receive access to survey forms; however, their past survey data will remain accessible to the HRM and anyone else with access to the organization's data); Access “My HRM Message Center,” where the HRM may create, send, view and reply to private messages to/from HRs within the HRM's organization; Submit program news to appear on the home page of the organization's Web site and on each HR's Human Resources Space page; Access the “Download Center,” a page containing links to award and certificate templates that HRMs can download, personalize and send via e-mail to HRs; Contribute a resource to Tier 1 of the Two-Tiered Success Story Permissions/Workflow System (described below) for the organization's Local Database; and View HRs' success stories and challenge stories from one's own organization and from organizations using the same instance of the system,

Creating Surveys

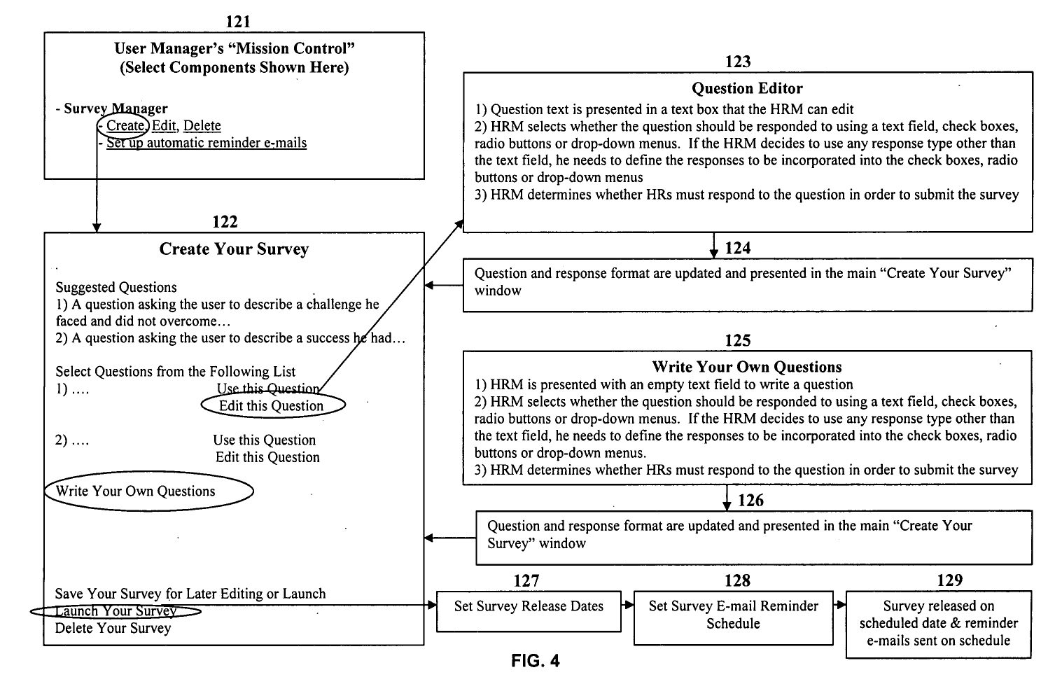

FIG. 4 illustrates a flow diagram for creating surveys. Once organizations register to use the system, HRMs create a Web-based survey for their HRs to complete at regular intervals (e.g., daily, weekly, bi-weekly, monthly, half-yearly, annually). HRMs do this by logging into their “Survey Manager” page from their Mission Control 121 and creating their questions 122 through 126 by either selecting pre-written questions that the service provider has produced, editing those questions, or entering new questions into a text field and selecting how users should respond to the question. HRMs may also create single or multi-part questions that may be answered by entering data into a text field, selecting check boxes, selecting radio buttons, or selecting items from a drop down menu.

All organizations using the system are encouraged to incorporate two questions into their surveys. One question asks HRs to describe the greatest success they had working in the organization during a certain time period. Another question asks HRs to describe a goal or challenge. This description of the present invention assumes the organization uses these two questions.

After HRMs finish selecting, editing and creating their questions, they can preview their surveys, reorder questions, save the survey for later editing, and/or set survey release dates. HRMs may select general survey release dates 127 such as “every other Monday” or “Every first of the month”, or more specific dates such as “March 10^{th}, April 11^{th}, or May 21^{st}”. HR managers can also instruct the system to release the survey to some HRs with differing characteristics (e.g., releasing a survey to new HRs weekly, and releasing a survey to HRs who have been with the organization for a year bi-weekly).

Once HRMs select their survey release dates, they select whether the system should send their HRs automated e-mail reminders to complete the surveys 119. If the HRMs opt to use the reminders, they must decide, in units of days and hours in relation to the expiration date of the survey, when the reminders should be e-mailed to each HR, such as 24 hours before the expiration of a survey. Each reminder e-mail contains a link to the organization's Web site, directions on how to load the survey, and the HR's Human Resources Space access information. These reminder e-mails also contain the HRM's contact information and the system manager's phone number in case the HR needs technical support.

Block 120 shows that once an organization schedules an e-mail reminder service, the organization's survey will be automatically released on the designated date at a certain time set by the system. The system will automatically post a link to the survey form in each HR's Human Resources Space page. It is possible for more than one survey form to simultaneously be in a released state, and HRMs can always change the release schedules of their surveys (e.g., releasing surveys bi-weekly instead of weekly).

Human Resources Space

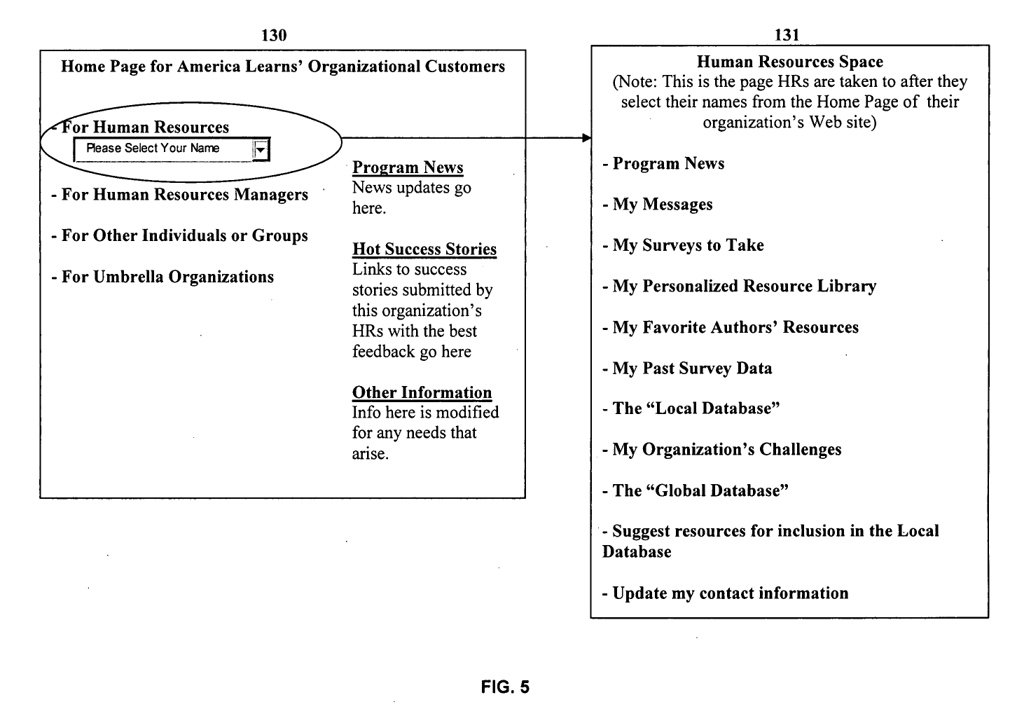

FIG. 5 illustrates the “Human Resources Space”—the portion of the system where HRs access surveys and receive support to help them carry out their job functions. When an HR enters her access information on the home page of her organization's Web site 130, she is taken to her “Human Resources Space” 131, a personalized page that allows her to: View program news updated by her HRM; Access “My Messages,” where she may create, send, view and reply to private messages from her HRM and other HRs within her organization and outside of her organization using the same instance of the system; Access surveys she hasn't yet completed; Access her personalized resource library, a list of links to the resources the system suggests to her over time based on the challenges she reports in her surveys. Access her favorite authors' support resources (described below); Access her past survey data; View the Local Database; View the Global Database; Suggest resources to be included in her organization's Local Database; and Update her contact information (the information the system uses to contact her).

Completing Surveys

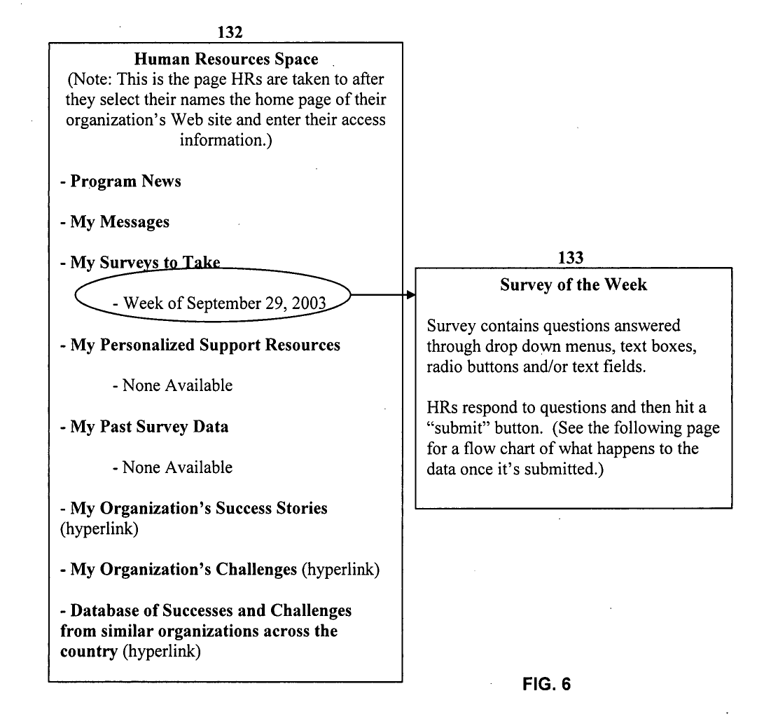

FIG. 6 illustrates how HRs access and complete surveys. To complete the periodic surveys, HRs first enter their Human Resources Space from their organization's Web site home page 132 and click the link for a survey they need to take. Then, they complete and click a button to “submit” their surveys, which stores all survey data into several tables in the relational database.

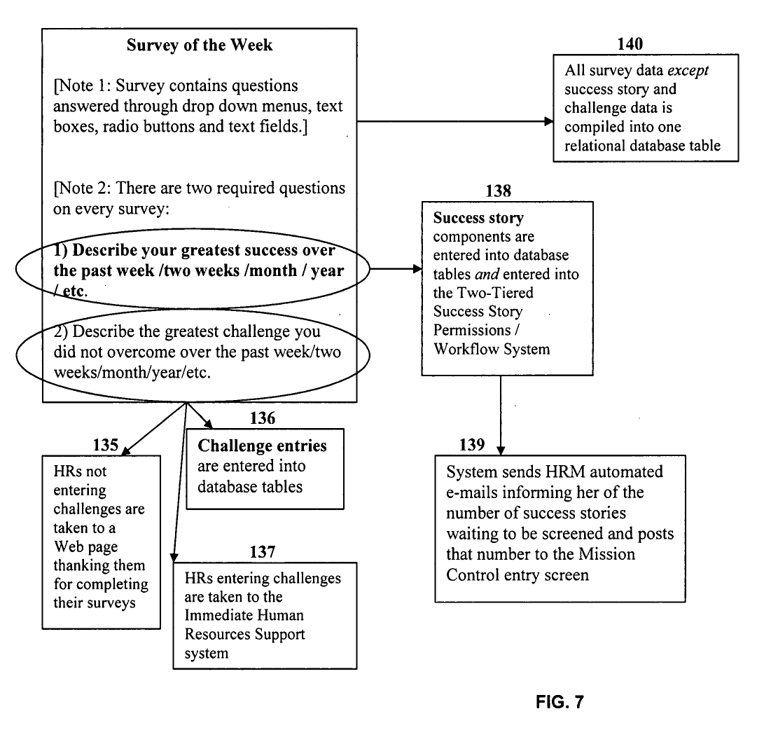

FIG. 7 provides an overview of what actions the system takes as soon as HRs submit surveys to the system. First, all data is posted to various tables in the relational database. Block 135 shows that HRs' responses to the success and challenge story questions are posted separately from the rest of the survey data. The success and challenge story data are posted to their own tables (shown in 129 and 136, respectively). HRs not recording challenges on their surveys will be taken to a page that thanks them for taking time to record their data 135. Blocks 136 and 137 show that if the HR describes a challenge in her survey, the challenge submission enters the “Immediate Human Resources Support” system (described below).

If the HR describes a success story in her survey, the success story survey enters the Two-Tiered Permissions/Workflow System 138, and the HRM receives notice via automatically-sent e-mails and postings to her Mission Control that strategies are awaiting her review 139.

The Two-Tiered Success Story Permissions/Workflow System & the Local and Global Resource Databases

The Two-Tiered Success Story Permissions/Workflow System illustrated in FIG. 7 is used to screen, approve, disapprove, and remove success stories from the organization's Local Database and the Global Database shared by all organizations accessing the same instance of the system. Specifically, the system allows each HRM to edit and post success stories submitted by her HRs to her organization's private Local Database of success stories. It also allows system managers to edit and post those success stories already posted in the Local Database to a Global Database.

Tier 1 of the Two-Tiered Success Story Permissions/Workflow System works in the following way: When an HR submits a success story via her survey or via the resource suggestion hyperlink on her Human Resources Space, or when an HRM submits a resource via the resource suggestion hyperlink in her Mission Control, the success story/resource entry is inserted into database tables and the local HRM receives an e-mail and notice on her Mission Control informing her that a new resource has been submitted to Tier 1 of the Permissions/Workflow System. The HRM also receives weekly e-mails and notices posted on her Mission Control informing her of the number of success stories waiting to be reviewed in Tier 1.

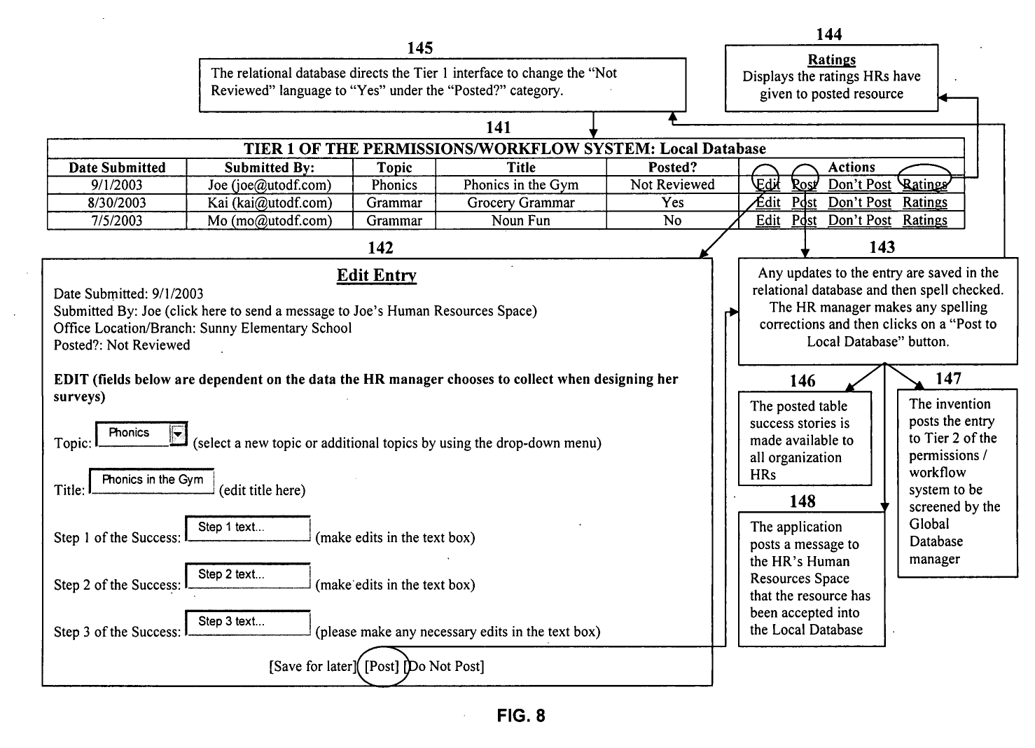

The HRM enters the Permissions/Workflow System through a hyperlink in the notification e-mail or via a link on the HRM's Mission Control page. FIG. 8, block 141 shows that all of the success stories that have been submitted to the system are organized in chronological order in a table by the date they were submitted, with the most recent success story at the top of the screen. Resources are sub-categorized by topic category. Resources may be assigned to one or more topics.

The table is divided into six sections: the date the success story was submitted; the name and e-mail address of the HR who submitted the success story; the topics of the success story; the title of the success story; notification as to whether the success story has been screened, approved or disapproved for posting to the database; and a series of four hyperlinks. Following is a functional description of each of the four hyperlinks.

The “Edit” link allows the HRM to read and make edits to the submitted success story 142. HRMs may modify a success story's title, topic, any other categories the HRM created while creating her survey (e.g., a literacy tutoring program might ask HRs to note the grade levels of the students involved in any success story), and any of the language describing the success.

The “Post” links illustrated in 141 and 142 allow the HRM to initiate the process of posting a resource to the Local Database. Before posting, the resource is first taken through a spell checker application 140 that asks the HRM to correct any unrecognized words. After the spell check is complete, the HRM clicks a “Post to Local Database” button, which directs the relational database containing the success stories to display the newly posted success story to all organization HRs via the Local Database, accessed through the Human Resources Space pages and the Immediate Human Resources Support System (described below). Block 148 shows that once an organization posts a success story to its Local Database, the system posts a message to the Human Resources Space of the HR who recorded the success story, informing her of its acceptance into the Local Database. Block 147 shows that once an organization posts a success story to its Local Database, the system posts the story Tier 2 of the Permissions/Workflow System for review by the Tier 2 manager.

The “Don't Post” links in blocks 141 and 142 prevent a success story from being viewed in the Local Database and the Global Database. When an HRM uses this feature, the word “No” is displayed in the table's “Post” column. HRMs may also use this feature to remove already-posted success stories from the Local Database.

The “Ratings” link and display in 141 and 144, respectively, allow the HRM to view the ratings and feedback HRs are giving to resources in the Local Database.

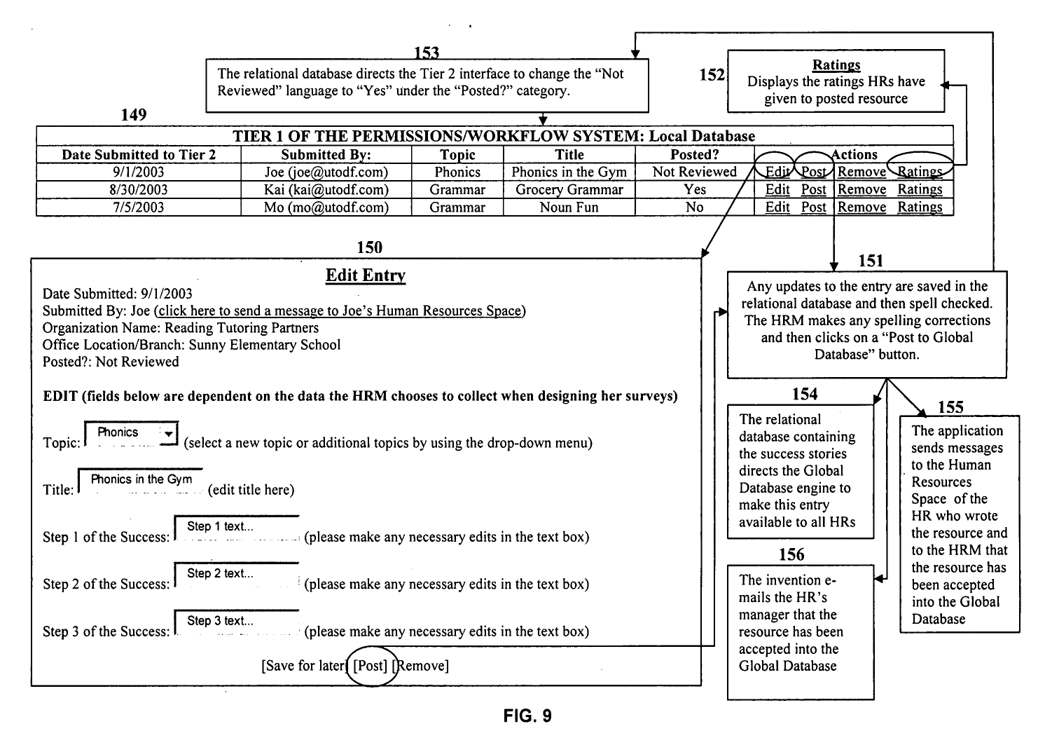

FIG. 9 details Tier 2 of the Two-Tiered Success Story Permissions/Workflow System, which works in the following way: If two or more organizations are using the same instance of the system, whenever an eligible organization adds a resource to its Local Database via Tier 1, the Tier 2 manager (most often the system manager) receives notification that a resource has been sent to Tier 2 for review via e-mail and a bulletin on a private Web page he accesses.

The Tier 2 manager enters the permissions/workflow system through his private Web page. Block 149 shows that all of the success stories that have been submitted to the system are organized in chronological order in a table by the date they were submitted, with the most recent success story at the top of the screen. Resources are sub-categorized by topic category. Resources may be assigned to one or more topics.

The table is divided into six sections: the date the success story was submitted; the name and e-mail address of the HR who submitted the success story; the topics of the success story; the title of the success story; notification as to whether the success story has been screened, approved or disapproved for posting to the database; and a series of four hyperlinks. Following is a functional description of each of the four hyperlinks.

The “Edit” link allows the HRM to read and make edits to the submitted success story 150. HRMs may modify a success story's title, topic, any other categories the HRM created while creating her survey (e.g., a literacy tutoring program might ask HRs to note the grade levels of the students involved in any success story), and any of the language describing the success.

The “Post” links illustrated in 149 and 150 allow the HRM to initiate the process of posting a resource to the Local Database. Before posting, the resource is first taken through a spell checker application 151 that asks the HRM to correct any unrecognized words. After the spell check is complete, the HRM clicks a “Post to Global Database” button, which directs the relational database containing the success stories to display the newly posted success story to all HRs using that instance of the system, accessed through the Human Resources Space pages and the Immediate Human Resources Support System (described below). Block 155 shows that once an HR's success story is promoted to the Global Database, the system posts a message to the Human Resources Space of the HR who recorded the success story, informing her of its acceptance into the Global Database. Block 156 shows that once an HR's success story is posted to the Global Database, the system automatically e-mails the HR's manager informing her of the story's promotion.

The “Remove” links in blocks 149 and 150 prevent remove the success story from the Local Database. The “Demote” link in 149 allows the Tier 2 manager to demote a current Global Database resource back to a Local Database posting only.

The “Ratings” link and display in 149 and 152, respectively, allow the HRM to view the ratings and feedback HRs are giving to resources in the Local Database.

The Challenge Story Database

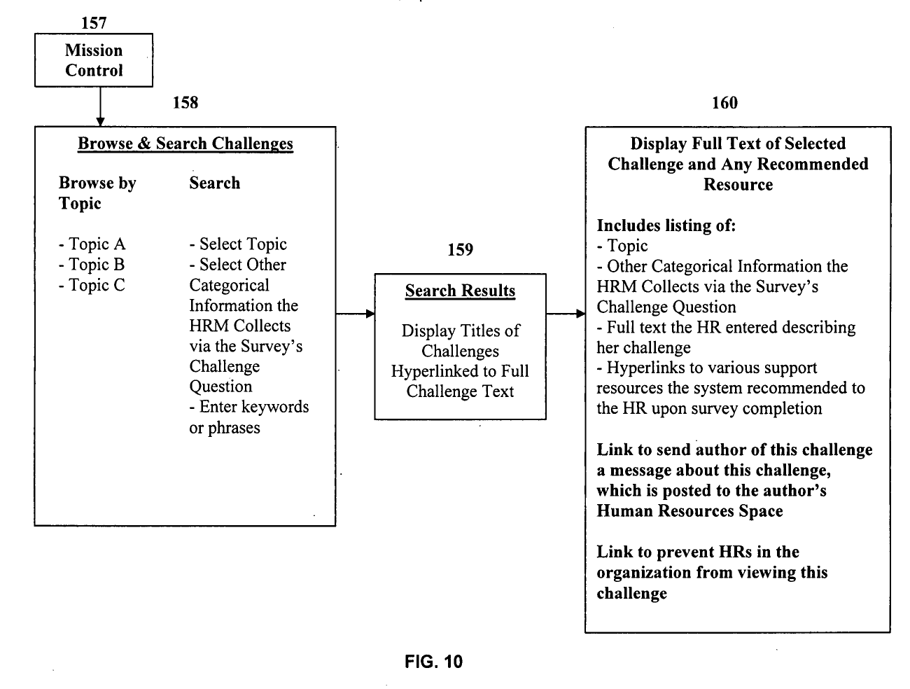

FIG. 10 illustrates how HRMs gain access to and use the challenge stories HRs contribute via their surveys. HRMs may browse or search through all of the challenge stories, as well as the resources the system recommended to overcome those challenges.

HRMs access the portion of the system allowing them to browse and search through the challenge stories 158 from a link within their Mission Controls. To browse the challenges, users simply click on the topic that interests them. To search the challenges, users do any or all of the following: select the topic or topics that interest them; select any other categorical information the HRM built into the challenge question on the survey (e.g., a reading tutoring program might ask tutors to note the number of children they are working with or their work setting); and enter relevant keywords and key phrases. The Search Results page 159 displays hyperlinks to the relevant challenges.

The table at the top of the page displaying the challenge HRMs select to view on the Search Results page 160 lists: the topic category of the challenge; any other categorical information the HRM built into the challenge question on the survey; and the text of the challenge story. The page also displays links to the various support resources the system suggested to the HR recording the challenge. A hyperlink on the page takes HRs to a Web page that allows users to send a message (e.g., feedback) to the “My Messages” section of the Human Resources Space of the HR who reported the challenge. Another hyperlink on the page allows an HRM to add or remove this challenge from HRs' view. When an HRM clicks on that hyperlink, and the challenge is currently viewable by HRs (by default, all challenges are viewable by HRs), HRs are no longer able to view the challenge. Likewise, if a challenge is already hidden from HR view, when the HR manager clicks this hyperlink, the challenge becomes visible to HRs. HRMs are unable to edit the challenges that HRs record in their surveys.

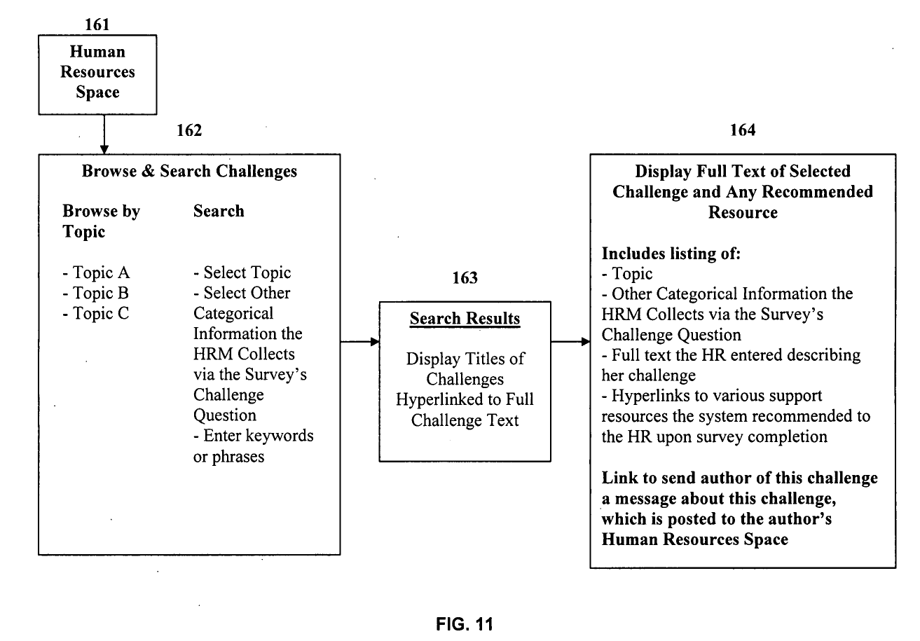

FIG. 11 illustrates how HRs gain access to and use the challenge stories HRs contribute via their surveys. HRs may browse or search through all of the challenge stories, as well as the resources the system recommended to overcome those challenges, EXCEPT those hidden by HRMs. HRs access the portion of the system allowing them to browse and search through the challenge stories 162 from a link within their Human Resources Spaces. To browse the challenges, users simply click on the topic that interests them. To search the challenges, users select the topic or topics that interest them, select any other categorical information the HTM built into the challenge question on the survey (e.g., a reading tutoring program might ask tutors to note the number of children they are working with or their work setting), and enters relevant keywords and key phrases. The Search Results page 163 displays hyperlinks to the relevant challenges.

The table at the top of the page displaying the challenge HRs select to view on the Search Results page 164 lists: the topic category of the challenge; any other categorical information the HRM built into the challenge question on the survey; and the text of the challenge story. The page also displays links to the various support resources the system suggested to the HR recording the challenge. Lastly, a hyperlink on the page takes HRs to a Web page that allows users to send a message (e.g., feedback) to the “My Messages” section of the Human Resources Space of the HR who reported the challenge.

The Immediate Human Resources Support System:

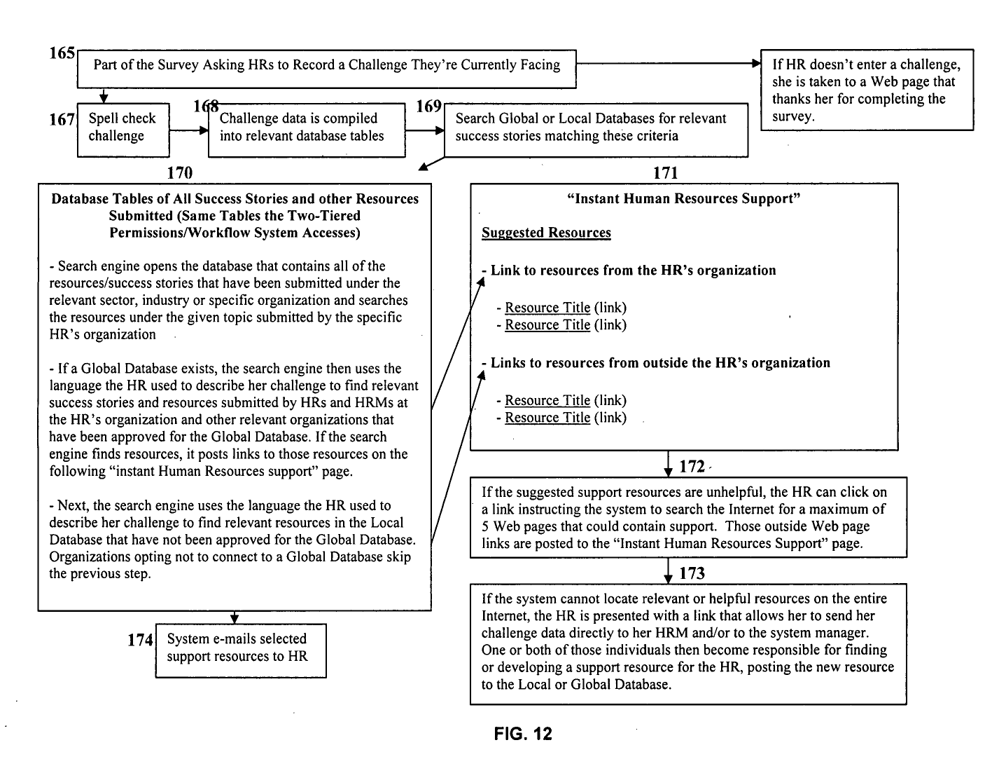

FIG. 12 is a flow diagram illustrating how the system attempts to use the Immediate Human Resources Support System to provide an HR identifying challenges in a survey. As illustrated previously in FIG. 7, challenge data entered in surveys are taken to their own relational database tables. After storing the challenge data in those tables, the system uses the challenge data and other stored HR characteristics to conduct search processes to find resources to help the HR overcome her challenge.

The first two search processes work as follows: Once the challenge data is spell checked 167 and stored in the relevant database tables 168, a search engine 169 opens the database tables of success stories and resources that the Two-Tiered Permissions[Workflow System uses 170.

The search engine first uses the language the HR used to describe her challenge and other information collected in the survey and already stored in the system to find relevant resources submitted by HRs and HRMs at the survey taker's organization and other organizations connected to the same Global Database. If the search engine finds resources, the system posts links to those resources on the following Instant Human Resources Support Web page 171, the first page an HR who submitted a challenge sees after submitting her survey and completing the challenge spell checking process. Next, the search engine tries to find relevant resources in the Local Database that have not been approved for the Global Database. The system posts links to any Local Database resources on the following “Instant Human Resources Support” Web page.

If the suggested support resources are unhelpful or if the system fails to find relevant resources in the Local and Global Databases, the HR can click on a link on the Instant Human Resources Support page instructing the system to search the Internet and retrieve a limited number of Web pages that may contain adequate support resources for the HR 172. Those outside Web page links are added to the Instant Human Resources Support page. The outside Web pages are displayed with a horizontal frame at the top of the Web browser window encouraging the HR to click on one of two links: “This is a helpful resource” or “Back to my Immediate Human Resources Support Page.” If the HR clicks on “This is a helpful resource,” that Web page address is immediately entered into the second tier of the Two-Tiered Permissions[Workflow System for review.

In block 173, we see that if the system cannot locate relevant or helpful resources on the entire Internet, the HR is presented with a link that allows her to send her challenge data directly to her HRM and/or to the system manager. When the HR clicks on the hyperlink, she is presented with a text box form asking her to describe the reasons the suggested resources do not meet the HR's needs. The HRM or system manager then becomes responsible for finding or developing a support resource for the HR, and posting the new resource to the Local or Global Database. The system automatically posts this resource to the HR's Human Resources Space.

Whenever the system suggests resources to HRs or when HRMs or system managers create a resource from scratch for an HR, the system will e-mail that HR a copy of the challenge text she entered in the survey, a link to the suggested resource or resources, a link to her Human Resources Space, and her Human Resources Space access information, 174.

Updating the Human Resources Space

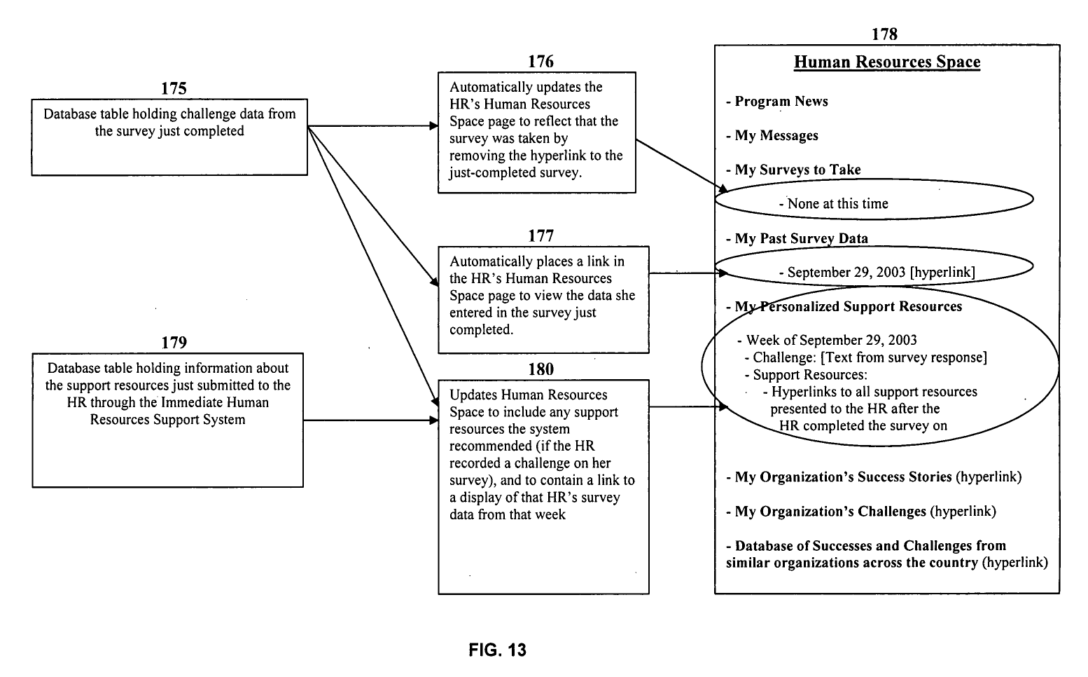

FIG. 13 illustrates how the system updates an HR's Human Resources Space after an HR completes a survey. As shown in blocks 175, 176 and 178, as soon as an HR completes a survey, the system automatically updates the HR's Human Resources Space page to reflect that the survey was taken by removing the hyperlink to the just-completed survey. As shown in blocks 175, 177 and 178, the system also automatically adds a link to the HR's most recent survey data to the Human Resources Space page under the “My Past Survey Data” section.

If the HR just completing a survey recorded a challenge in her survey, the system reads information from the database tables holding the challenge text and the resources the system recommended to the HR to update the Human Resources Space with hyperlinks to the resources under “My Personalized Support Resources, “as illustrated in 175, 179, 178 and 180.

HR Rating of Resources

Only HRs are able to rate the quality of the support resources in the Local and Global Databases. When an HR views a resource in a Local or Global Database, the resource contains a “utility rating” section in which HRs rate resources' relevance on a 1 to 5 scale via drop-down menus, radio buttons or check boxes. “1” is identified with the phrase, “This resource is not relevant to my challenge,” and “5” is identified with “This resource is highly relevant and useful.” Those ratings are stored in the same relational database table as the resources.

Compiling and Viewing Survey Data:

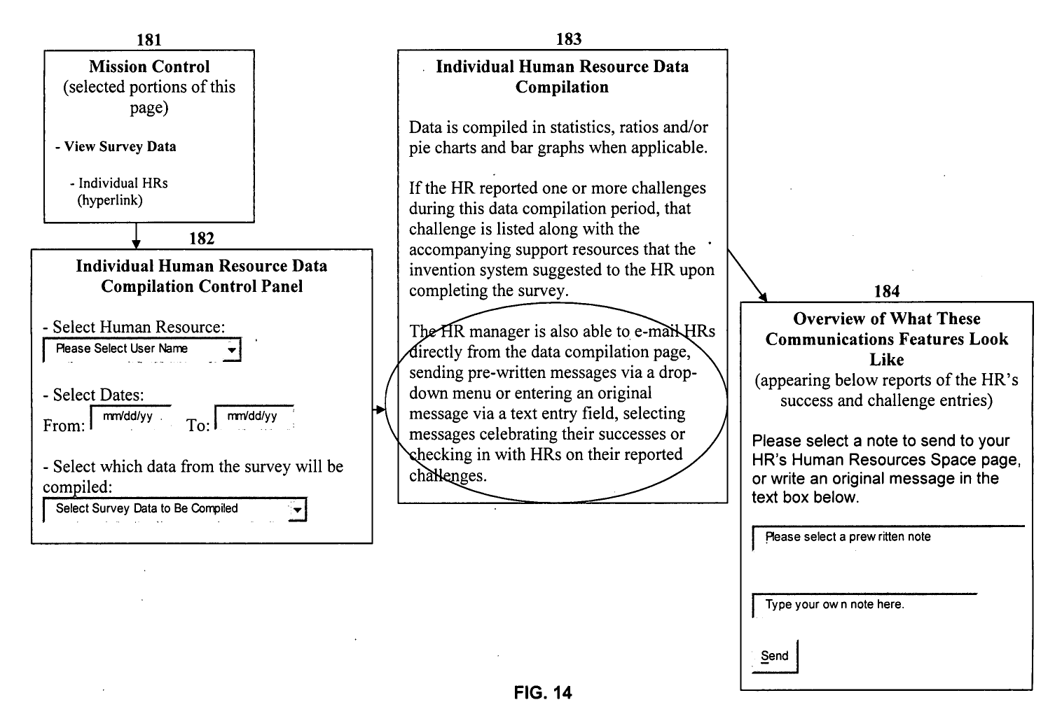

HRMs are able to use options in their Mission Control pages to compile and view their HRs' survey data in three ways. The first way is by individual users. FIG. 14 is a flow diagram illustrating how a human resources manager uses the invention to view survey data for individual human resources. Blocks 182 and 183 show that the HRM selects the user she would like to view data for via a drop-down menu (which includes names of inactive users), selects the time period she would like data for, selects which survey question responses she would like to view, and then hits a “submit” button to direct the system to compile, aggregate and display qualitative data via text and quantitative data in integers, decimals, percentages, graphs, and charts. If the HRM chooses to view the text of an HR's reported challenge or challenges, the system displays the challenge or challenges along with links to all of the support resources that the system suggested to the HR via the Immediate Human Resource Support System. Blocks 183 and 184 show that when HRMs view an individual HR's survey data, a drop-down menu or a link to a pop-up window is placed by the success story and challenge data that allow HRMs to send pre-written (editable) e-mails and messages to users' Human Resources Space pages or e-mail accounts.

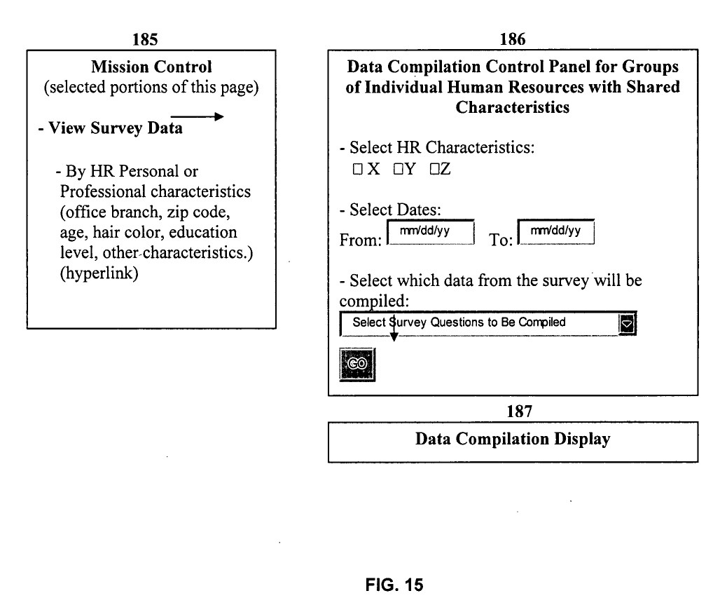

FIG. 15 shows that users may view survey data by groups of individual users with shared personal or professional characteristics. When organizations register to use the system, they determine the types of information about their HRs that they'd like to collect (from the office branch they work in to their age). The HRM is able to direct the system to compile data for individuals sharing any of these personal or professional characteristics. After the HRM selects their characteristics in which she's interested, the HRM selects the time period she'd like data for, which survey question responses should be displayed, and whether only active, only inactive, or whether all HRs should be accounted for 186. The HRM then submits her data compilation request and the system compiles and displays the qualitative and quantitative data 190.

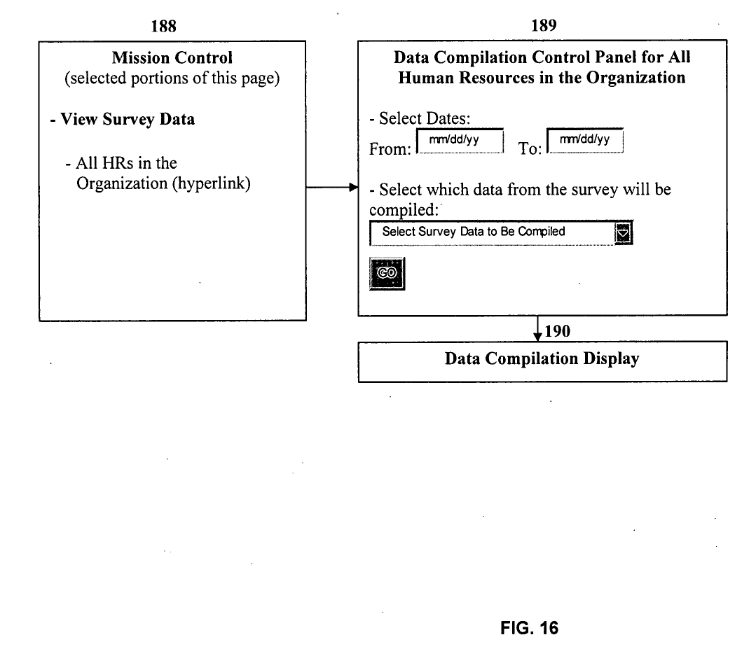

FIG. 16 shows that users may instruct the system to compile and display survey data by all of the HRs in the entire organization over any time period. The HRM selects the time period she'd like data for, and selects which survey questions responses should be displayed, selects whether only active, only inactive, or whether all HRs should be accounted for. The HRM then submits her data compilation request and the system compiles and displays the qualitative and quantitative data.

To maintain consistency across all graphs and charts, the system randomly assigns specific colors to each success and challenge topic to prevent HRM confusion when comparing multiple sets of data over time (e.g., in the reading tutoring sector, phonics could always be represented in color “#000080”). No two topics share the same color. The Data Compilation Process for Umbrella Organizations & “Other Individuals and Groups”

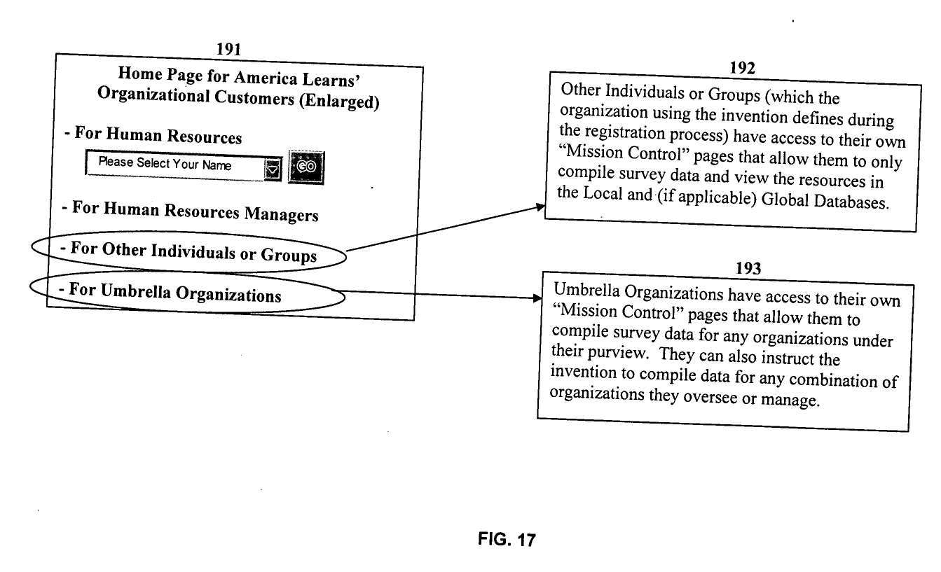

FIG. 17 illustrates how populations other than HRMs compile and view HRs' survey data. As show in blocks 192 and 193, like the HRMs, these individuals and organizations have a password-protected “Mission Control” linked to from the organization's home page; however, their Mission Control is limited in functionality, as it can only view survey data by following the identical processes described above and illustrated in FIGS. 14, 15 and 16.

Basic Structural Overview of the System

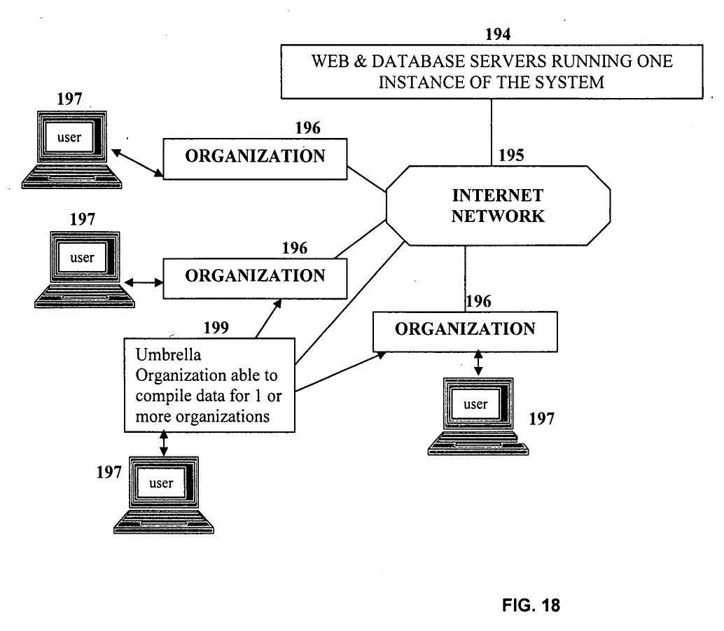

FIG. 18 presents the basic structural overview of the system. The system is typically housed on a Web server and SQL database server 194 that is connected to the public Internet 195, though it may also run off an intranet. HRs, HRMs and other users access and use the system via a Web browser on an adequately equipped computing device (such as a desktop computer, a notebook computer, or a wireless device).

1. A human resource management system comprising
a network that provides an organization and a human resource access to the system,
an organization specific content area comprising a home page,
wherein the organization creates a survey within its own content area,
wherein the organization permits the system to provide access to the content area to the human resource,
wherein the system delivers the survey to the human resource,
wherein the human resource provides a response to the survey, and
wherein the organization accesses the response of the human resource.

2. The system of claim 1 wherein the system registers the organization.

3. The system of claim 1 wherein the content area provides for differentiating access between the human resource taking the survey and the organization creating the survey.

4. The system of claim 2 wherein the content area provides for differentiating access between the human resource taking the survey and the organization creating the survey.

5. The system of claim 1 wherein the system provides the human resource with general or customized information.

6. The system of claim 2 wherein the system provides the human resource with general or customized information.

7. The system of claim 3 wherein the system provides the human resource with general or customized information.

8. The system of claim 4 wherein the system provides the human resource with either general or customized information.

9. The system of claim 5 wherein the organization can modify the general or customized information to be provided to the human resource.

10. The system of claim 6 wherein the organization can modify the general or customized information to be provided to the human resource.

11. The system of claim 7 wherein the organization can modify the general or customized information to be provided to the human resource.

12. The system of claim 8 wherein the organization can modify the general or customized information to be provided to the human resource.
